(19) United States
(12) Patent Application Publication
(10) Pub. No.: US 2003/0151197 A1
(43) Pub. Date: Aug. 14, 2003

(54) Gambling casino new/improved process for gambler attraction and higher yields

(76) Inventor: Ned Harris Presley, Casselberry, FL (US)

Correspondence Address: Ned H. Presley, 52 Carriage Hill Cir., Casselberry, FL, 32707, US

(21) Appl. No.: 10/073,586

(22) Filed: Feb. 12, 2002

(51) Int. Cl. A63F 13/00

(52) U.S. Cl. 273/274

(57) ABSTRACT

A new Gambling casino process for increased yields by providing or permitting upper body massage by attendants to gamblers while still gambling.

### BACKGROUND OF THE INVENTION

Many enticements, promotions, attractions, incentives, awards and rewards are used by gambling casinos to attract gamblers to the casino and to keep them gambling in the casino at the tables, machines, and all gambling stations and areas with out interruption as long as possible. These are known and described in a large number of publications and newspaper advertisements. While gamblers are gambling in the casino area at the gambling stations, tables, machines, sports booking and keno betting areas the most prominent stress relief and relaxer, incentive and inticement to gamblers to continue the gambling session has been the liberal serving of free or low cost alcoholic drinks. This practice requires a cost to the casino for the liquor and may expose the casino to liability lawsuits.

This invention relates to a new and novel and improved process for casinos to attract gamblers and increase yields by providing or permitting stress relief, relaxing types of shoulder, neck and/or upper body massage and manipulation, as the gambler continues his gambling without leaving the casino gambling area, station, table, machine, sports booking or keno areas. This process will increase yields by increasing longer uninterrupted gambling sessions by gamblers.

This new process may reduce alcohol related liability lawsuits. This new process may be largely cost free to the casino, being funded totally or largely by gambler tips to the attendants, providers and/or practitioners.

Prior to this new invention process all massage and relaxing types of services have been available only in certain hotel, spa and salon areas set apart from the gambling casino, gambling areas, tables, machines, etc. resulting in an interruption of the gambling session and reduced yields.

### SUMMARY OF THE INVENTION

The invention is a new and improved process for gambling casinos to attract more gamblers and keep them gambling and in the casino gambling stations and areas for longer uninterrupted sessions. To do so by providing or permitting stress relief, relaxing types of gamblers upper body massage, at the gambling station, areas, tables, machines, sports book and keno areas. More gamblers, gambling for longer sessions resulting in higher yields for the casino.

### DETAILED DESCRIPTION OF THE INVENTION

A new/improved gambling casino process to attract more gamblers and keep them gambling longer, thus improving yields.

The new/improved process is the providing or permitting of upper body massages to gamblers while they continue to gamble.

The following is an example of specific, preferred steps of the new process by a gambling casino.

### EXAMPLE

### A

Casino securement of any required regulatory permits and licensees by state gaming commissions or other regulatory agencies.

### B

Casinos provide, select attendants or practitioners and provide training. Casinos secure attendants any necessary licenses or provide or permit vendors to perform upper body manipulation or massage to gamblers while gambling.

### C

Casino deploys and supervises massage-manipulation attendants to casino gambling areas to provide said services at intervals to gamblers while gambling.

### D

Casino design compensation program for massage manipulation attendants, emphasizing gambler tips.

### E

Casino select, design and designate, identifying costumes or uniforms for massage or manipulation attendants.

### F

Casino design and implement advertising, describing and promoting new stress relief and relaxing types of massage, manipulation while gambling in the casino.

It will be appreciated that various arrangements of the above-disclosed steps are possible without departing from the spirit of the present invention.

What I claim as my invention is:

1. A new gambling casino process providing or permitting stress relief and/or relaxing types of upper-body massage-manipulation to casino gamblers, as they are gambling in all casino gambling areas, including tables, machines, sports book and keno areas.

2. A new gambling casino process according to claim 1: performed by and utilizing uniformed or costumed identified attendants, vendors and/or practitioners.

3. A new gambling casino process according to claim 1; advertised and promoted by the casino.
